(19) United States
(12) Patent Application Publication
(10) Pub. No.: US 2021/0400915 A1
(43) Pub. Date: Dec. 30, 2021

(54) PET FURNITURE

(71) Applicant: Clawz LLC, Denver, CO (US)

(72) Inventor: Dominic Monahan, Denver, CO (US)

(73) Assignee: Clawz LLC

(21) Appl. No.: 17/184,874

(22) Filed: Feb. 25, 2021

Related U.S. Application Data
(60) Provisional application No. 63/045,326, filed on Jun. 29, 2020.

(51) Int. Cl. A01K 15/02

(52) U.S. Cl. CPC A01K 15/024; A01K 15/027

(57) ABSTRACT

A pet furniture apparatus that includes a first set of vertical support elements extending from a base portion to a first level of platforms. The vertical support elements extending from the base portion to the first level of platforms creates at least one compartment and a first floor. The pet furniture apparatus also includes at least one obstacle disposed in the at least one first level compartment to facilitate certain body movements of pets. At least one engagement element for the pet to engage can be incorporated into the pet furniture apparatus to induce interaction of the pet with the pet furniture apparatus. An end table or coffee table having a dual purpose as a pet furniture apparatus. The table includes a plurality of sides wherein each side has at least one access opening disposed therein. Each side of the table can be the top, bottom or side of the table. The table can also include a plurality of platform levels that creates multiple levels of compartments in a horizontal and vertical direction. A table top can be included that can be configured to rest atop any side of the table that is facing upwards.

### CROSS-REFERENCE TO RELATED APPLICATIONS

The present application is a conversion of U.S. Provisional Application having U.S. Ser. No. 63/045,326, filed Jun. 29, 2020, which claims the benefit under 35 U.S.C. 119(e). The disclosure of which is hereby expressly incorporated herein by reference.

### STATEMENT REGARDING FEDERALLY SPONSORED RESEARCH OR DEVELOPMENT

Not applicable.

### BACKGROUND OF THE DISCLOSURE

### 1. Field of the Disclosure

The present disclosure relates to pet furniture for use by animals to climb on, be entertained and get exercise. The present disclosure also relates to pet furniture that is built into regular furniture, such as a coffee table. Primarily, the pet furniture described herein is used by feline animals.

### 2. Description of the Related Art

Numerous devices and apparatuses have been created over the years to entertain and occupy pets. A lot of these devices and apparatuses are limited in what they offer for pets to do. These devices and apparatuses do not include enough elements for a pet to stay engaged for long periods of time and/or cause them to get adequate exercise and body movement. In most instances, pet furniture is a standalone device that is set out in a home and can be somewhat of an eyesore.

Accordingly, there is a need for pet furniture that can be designed in such a way and include certain elements that encourage more, and longer engagement of a pet with the pet furniture and facilitates certain body movement of the pets using the pet furniture. Furthermore, there is a need for regular furniture that incorporates pet furniture built therein for those looking to save space.

### SUMMARY OF THE DISCLOSURE

The present disclosure is directed toward a pet furniture apparatus that includes a first set of vertical support elements extending from a base portion to a first level of platforms. The vertical support elements extending from the base portion to the first level of platforms creates at least one compartment and a first floor. The pet furniture apparatus also includes at least one obstacle disposed in the at least one first level compartment to facilitate certain body movements of pets using the pet furniture apparatus. At least one engagement element for the pet to engage can be incorporated into the pet furniture apparatus to induce interaction of the pet with the pet furniture apparatus.

The present disclosure is also directed to an end table or coffee table having a dual purpose as a pet furniture apparatus. The table includes a plurality of sides wherein each side has at least one access opening disposed therein. Each side of the table can be the top, bottom or side of the table. The table can also include a plurality of platform levels that creates multiple levels of compartments in a horizontal and vertical direction. A table top can be included that can be configured to rest atop any side of the table that is facing upwards.

### BRIEF DESCRIPTION OF THE DRAWINGS

FIG. 1 is a perspective view of a pet furniture apparatus constructed in accordance with the present disclosure.

FIG. 2 is another perspective view of the pet furniture apparatus constructed in accordance with the present disclosure.

FIG. 3 is another perspective view of the pet furniture apparatus constructed in accordance with the present disclosure.

FIG. 4 is a perspective view of a portion of the pet furniture apparatus constructed in accordance with the present disclosure.

FIG. 5 is a perspective view of another portion of the pet furniture apparatus constructed in accordance with the present disclosure.

FIG. 6 is a perspective view of another portion of the pet furniture apparatus constructed in accordance with the present disclosure.

FIG. 7 is a perspective view of yet another portion of the pet furniture apparatus.

FIGS. 8A-8D are perspective views of another embodiment of a pet furniture apparatus constructed in accordance with the present disclosure.

FIGS. 9A-9D are perspective views of yet another embodiment of the pet furniture apparatus constructed in accordance with the present disclosure.

FIG. 10 is a perspective view of another embodiment of the pet furniture apparatus constructed in accordance with the present disclosure.

FIGS. 11A-11D are perspective views of a further embodiment of the pet furniture apparatus constructed in accordance with the present disclosure.

FIGS. 12A and 12B are perspective views of additional embodiments of the pet furniture apparatus constructed in accordance of the present disclosure.

### DETAILED DESCRIPTION OF THE DISCLOSURE

The present disclosure is directed to a pet furniture apparatus 10 that elicits longer engagement with the pet furniture apparatus 10 by pets and elicits more beneficial body movement from the pets. The pet furniture apparatus 10 can have many configurations as disclosed herein.

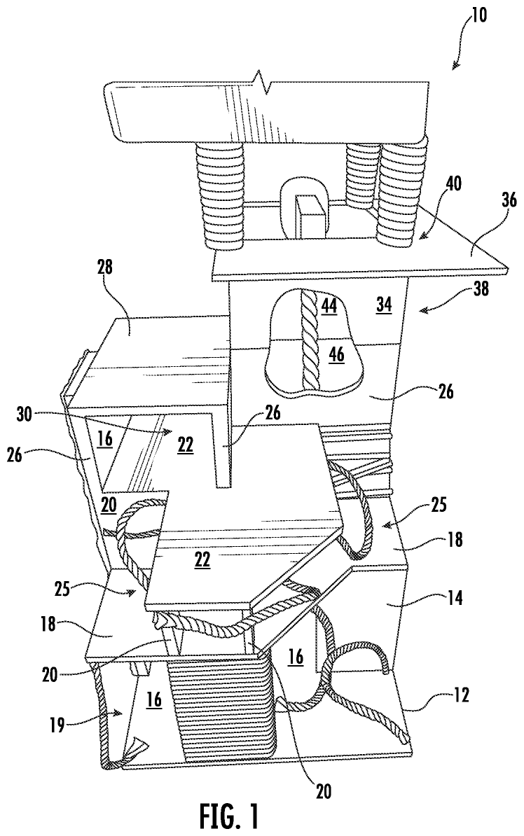

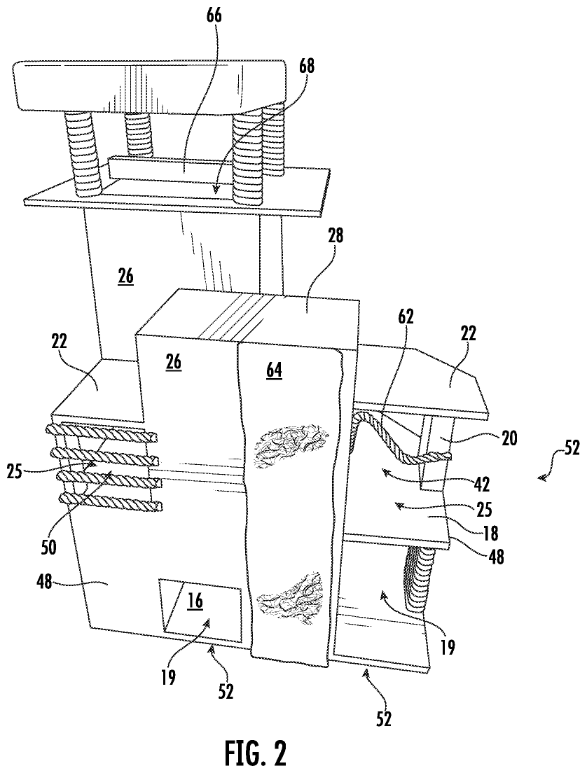

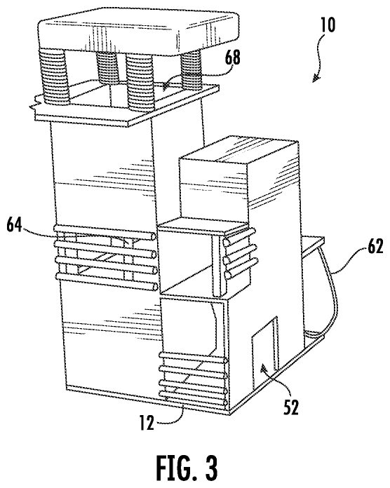

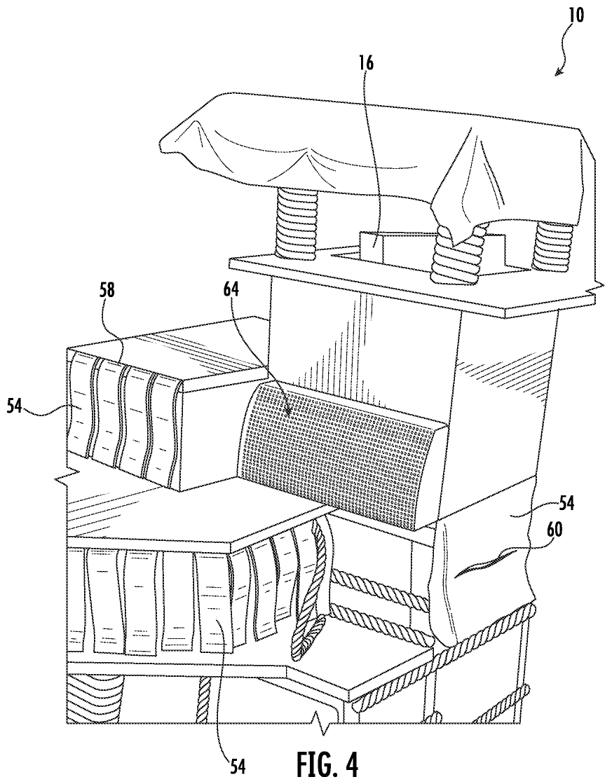

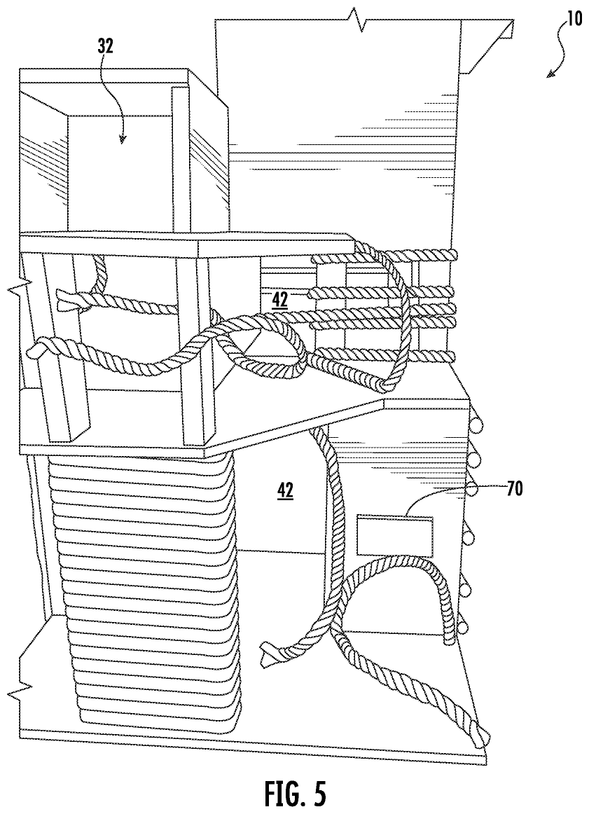

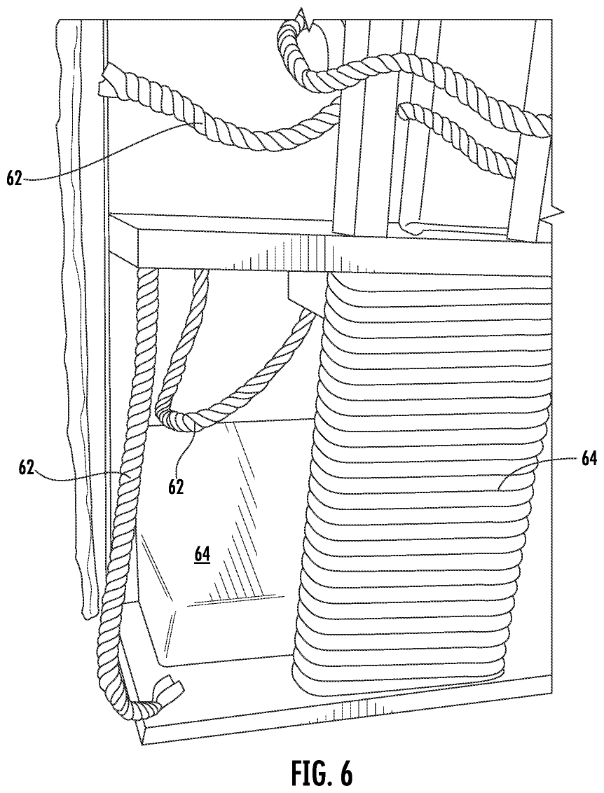

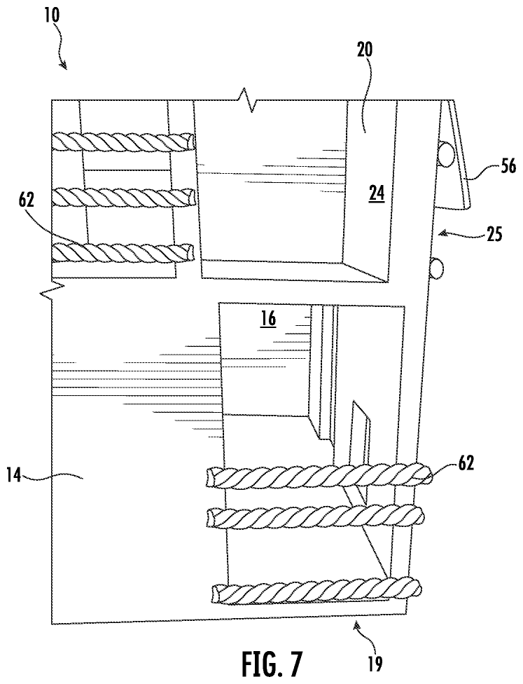

Referring now to FIGS. 1-7, in one embodiment, the pet furniture apparatus 10 can include a base portion 12 to support other elements of the pet furniture apparatus 10. Vertical support elements 14 can extend from the base portion 12 to create various compartments 16 in the pet furniture apparatus 10. The vertical support elements 14 can extend up to a first level of platforms 18. The space between the base portion 12 and the first level of platforms 18 creates a first floor 19 in the pet furniture apparatus 10. The pet furniture apparatus 10 can also include secondary vertical support elements 20 that extend from the first level of platforms 18 up to a second level of platforms 22. The secondary vertical support elements 20 create additional compartments 24 between the first level of platforms 18 and the second level of platforms 22. The space between the first level of platforms 18 and the second level of platforms 22 creates a second floor 25 in the pet furniture apparatus 10.

The pet furniture apparatus 10 can also include tertiary vertical support elements 26 that extend from the second level of platforms 22 up to a third level of platforms 28. The tertiary vertical support elements 26 create additional compartments 30 between the second level of platforms 22 and the third level of platforms 28. The space between the second level of platforms 22 and the third level of platforms 28 creates a third floor 32 in the pet furniture apparatus 10. In a further embodiment of the present disclosure, the pet furniture apparatus 10 can also include a fourth set of vertical support elements 34 that extend from the third level of platforms 28 up to a fourth level of platforms 36. The fourth set of vertical support elements 34 create additional compartments 38 between the third level of platforms 28 and the fourth level of platforms 36. The space between the third level of platforms 28 and the fourth level of platforms 36 creates a fourth floor 40 in the pet furniture apparatus 10. It should be understood and appreciated that the pet furniture apparatus 10 can have additional levels of platforms, vertical support elements and floors as desired. The base portion 10, platforms 18, 22, 28 and 36, and vertical support elements 14, 20, 26 and 34 can be constructed of any materials desired such that the structure maintains its shape and can support the pets that use it. Examples of materials include, but are not limited to, wood, metal, and polymer based materials, such as plastic.

Multiple compartments 16 can be created by the vertical support elements 14 between the second level of platforms 22 and the first level of platform 18 and the base portion 12. Horizontal passages 42 can be created between the compartments 16, 24 and 30 on each separate floor and vertical passages 44 can be made between adjacent floors. In another embodiment, the pet furniture apparatus 10 can include multi-floor passages 46 from one floor to another floor that is not disposed immediately adjacent. Some of the compartments 16, 24 and 30 will be positioned on an outer edge 48 of a given floor 19, 25 and 32 of the pet furniture apparatus 10. Some of the outer edge compartments 50 can have an open side 52 for allowing a pet access to the pet furniture apparatus 10 at different levels. In one embodiment, multiple sides of a compartment 16, 24 and 30 can be open. The open sides 52 of the outer edge compartments 50 can have flexible or cloth-like material 54 that cover the openings 52 or possibly a hinged or sliding cover plate 56. In some instances, the flexible or cloth-like material 54 can just hang from the top 58 of the opening 52 or hang from the top 58 of the opening 52 with multiple slits 60 in the flexible or cloth-like material 54. In another instance, the flexible or cloth-like material 54 can cover substantially all of the opening 52 and have a slit 62 or slot disposed therein to allow a pet to have to put forth some effort to get inside the pet furniture apparatus 10.

The compartments 16, 24 and 30 and passages—vertical 44 and horizontal 42—can include obstacles 62 that force the pet to take certain paths and distort their bodies in certain ways to navigate therethrough. The obstacles 62 are positioned specifically to force a pet to move their bodies in such a way that is good for them. Some obstacles 62 are positioned so that a pet has to bend to the left, bend to the right, duck under something, or go over something as the pet passes through the compartment 16, 24 and 30 or passageway 42 and/or 44. In one embodiment, a vertical passageway 44 can extend multiple floors up which forces the pet to stretch and reach to be able to get to the compartment at the top of the extended vertical passageway 44. Examples of obstacles 62 include, but are not limited to, pieces of rope or cords, pieces of wood, and the like.

The pet furniture apparatus 10 can also include pet engagement elements 64 disposed on and in the pet furniture apparatus 10. In certain embodiments, the engagement elements 64 can be textured or fibrous devices that the pets can interact with. For example, the engagement elements 64 can be pieces of corrugated materials, cardboard, ropes or cords, carpet and the like. These engagement elements 64 can be disposed inside various parts of the pet furniture apparatus 10 and/or attached to outside portions of the pet furniture apparatus 10. In one embodiment, an engagement element 64 can extend from a higher level floor to a lower level floor (or base portion) to permit the pet to climb from the lower level floor to the higher level floor. In this embodiment, the higher level floor would be disposed above the lower level floor a distance greater than the height of the pet so the pet has to climb the engagement element 64.

In one example, the engagement element 64 is corrugated material or carpet attached to a series of vertical support elements 14, 20, 26 or 34. In another example, the engagement element 64 is a rope or cord that is suspended from a rod 66 disposed across an open shaft 68 from an upper level to a lower level. The pets can climb the rope or cord to get to the upper level. The rope or cord can also just hang down from the upper level adjacent to the series of vertical support elements 14, 20, 26 or 34. In another embodiment, the vertical support elements 14, 20, 26 or 34 can include an engagement material disposed entirely around so that a pet can have a 360 degree part of the pet furniture apparatus 10 to interact with.

The pet furniture apparatus 10 can also include access points 70 that permit a user to place a treat or desirable object of the pet in certain locations to force the pet to traverse the obstacles and navigate through the pet furniture apparatus 10 to get to the place where the treats or desirable objects are placed.

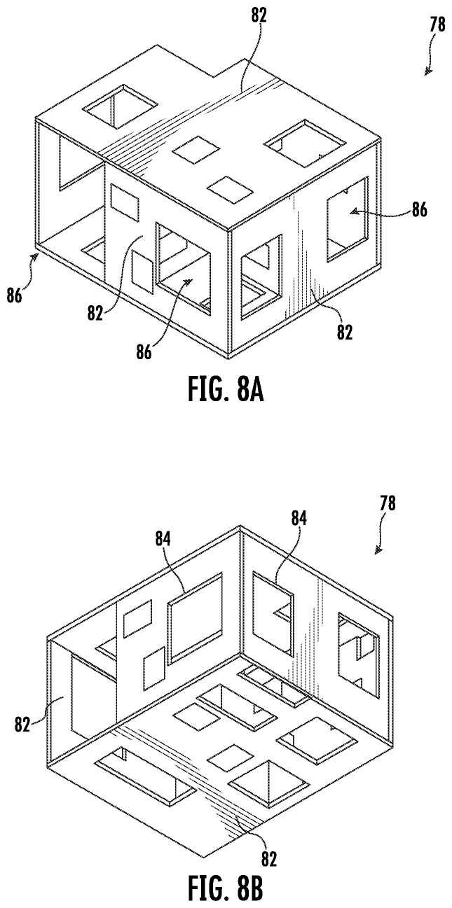

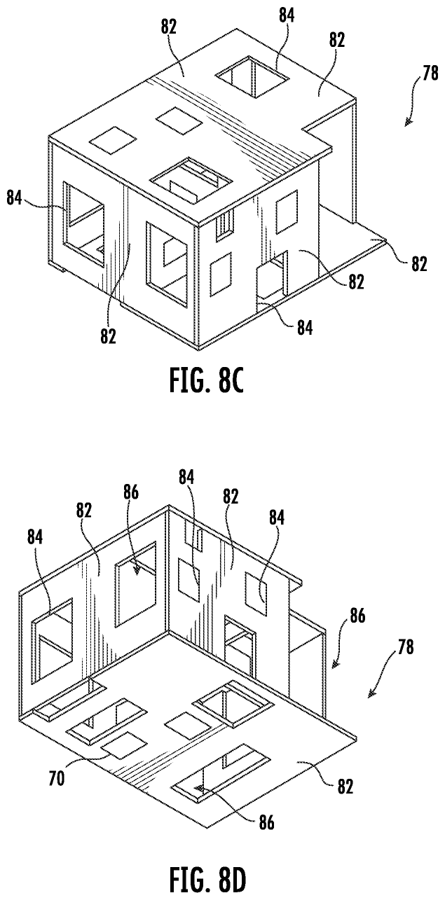

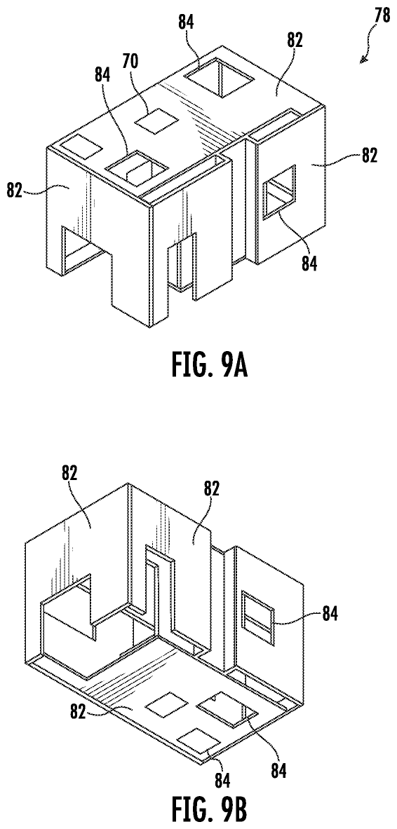

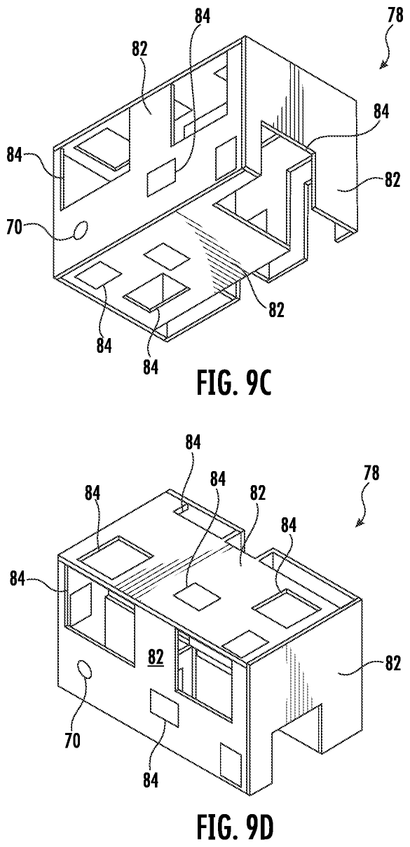

In yet another embodiment of the present disclosure shown in more detail in FIGS. 8A-9D, a pet furniture apparatus 78 can be built into a piece of home furniture, such as a coffee table, an end table, a couch, a chair, and a bed frame. It should be understood and appreciated that this list of home furniture is not an exhaustive list and any piece of home furniture is capable of being used to hide and support the pet furniture apparatus 78 as described herein. In one example, the piece of home furniture is a coffee or end table 80 that has a plurality of sides 82 that are ultimately supported by the floor of the house. The plurality of sides 82 can have at least one access opening 84 to allow a pet access to compartments 86 of the pet furniture apparatus as described herein. In another example, the plurality of sides 82 can include multiple access openings 84 to allow the pet multiple ingress and egress points to the pet furniture apparatus 78 inside the table.

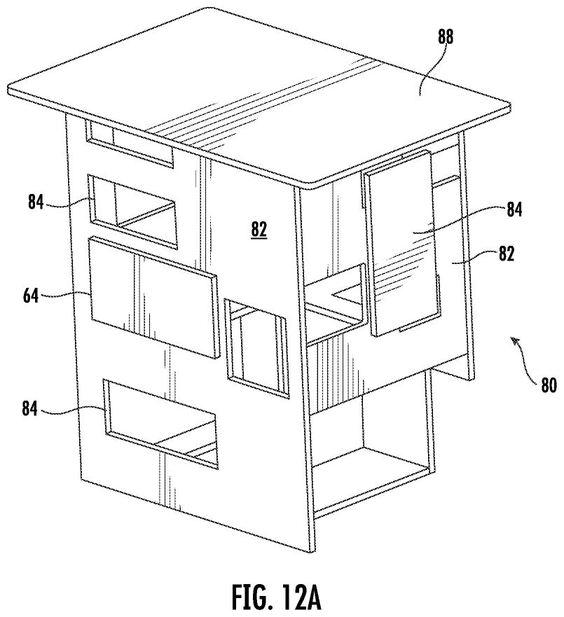

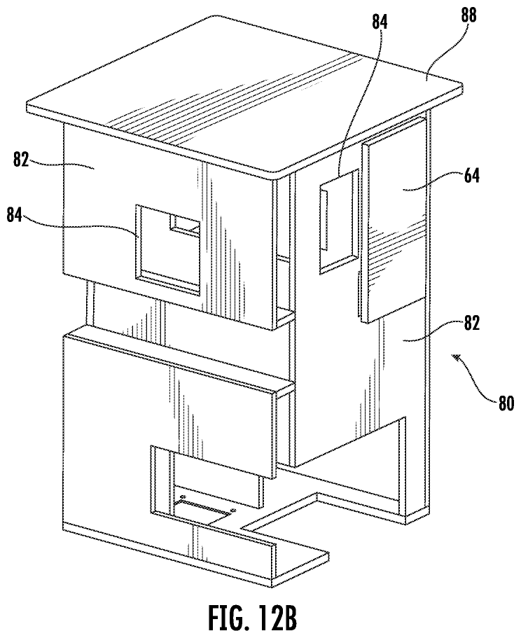

The pet apparatus furniture 78 that is used as home furniture can include all of the things described herein for the pet apparatus furniture 10. For example, the pet apparatus furniture 78 can have horizontal and vertical passageways 442 and 44, obstacles 62, pet engagement elements 64, etc. As shown in FIGS. 12A-12B, the pet furniture apparatus 78 can also include a table top 88 that can be placed on any side of the pet furniture apparatus 78, which would make that side 82 the top. In one embodiment, the table top 88 can be a transparent material, such as glass, so that a pet owner can look down into the pet furniture apparatus 78 and see their pet interacting with the pet furniture apparatus. The ability to put the pet furniture apparatus 78 on any one of its sides 82 permits the owner of the pet furniture apparatus 78 to change and control the look of the pet furniture apparatus 78.

In yet another embodiment of the present disclosure, the pet furniture apparatus 78 can include 6 sides 82 and each side 82 of the pet furniture apparatus 78 can include at least one access opening 84. In another embodiment, at least 5 sides of the pet furniture apparatus 78 includes two or more access openings 84 for the pet to gain access to the pet furniture apparatus 78. In a further embodiment, at least three sides 82 of the pet furniture apparatus 78 includes at least three access openings 84. In an even further embodiment of the present disclosure, at least three sides 82 of the pet furniture apparatus 78 includes at least four access openings 84. In certain embodiments, the access openings 84 can be partly defined by the floor the pet furniture apparatus 78 is placed on. All the access openings 84 on the different sides 82 allows access by the pets from all sides 82 and permits the pet owner to be able to see their pet from all sides 82.

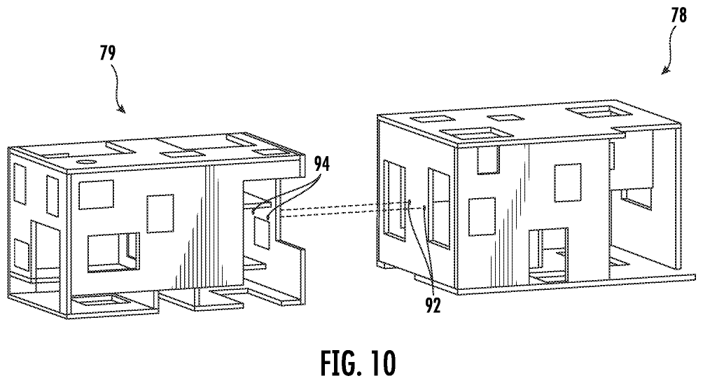

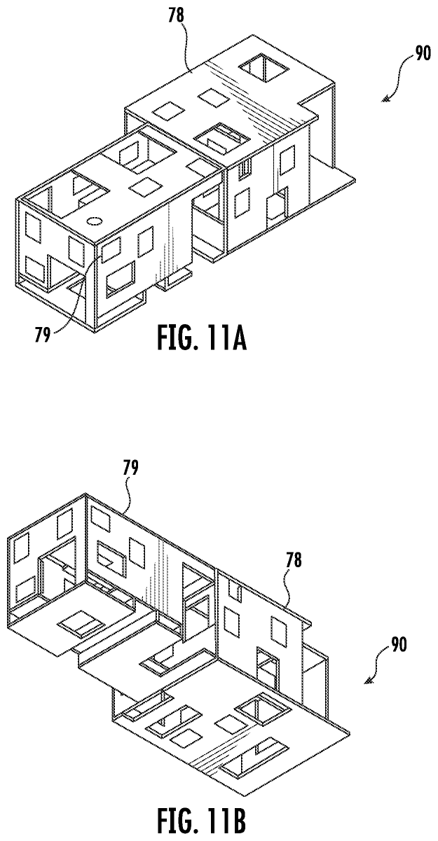

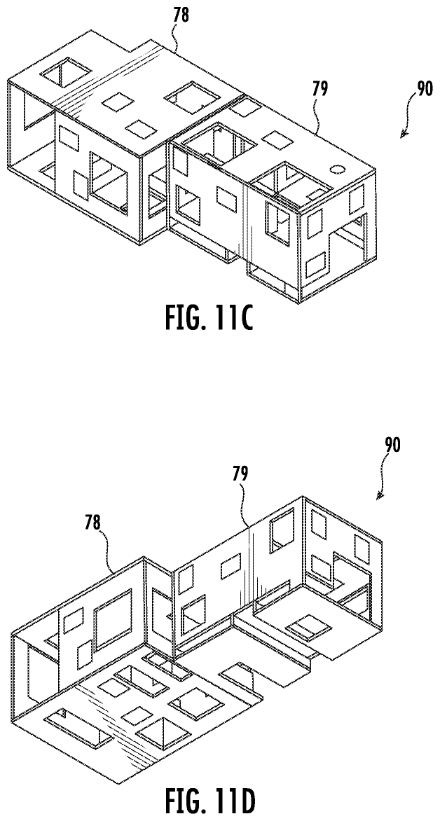

In a further embodiment of the present disclosure shown in FIGS. 10-11D, one pet furniture apparatus 78, which include one or more levels of platforms and one or more vertical support elements, or compartments can be combined with a second pet furniture apparatus 79 to create a combined pet furniture apparatus 90. The first pet furniture apparatus 78 and the second pet furniture apparatus 79 can each include at least one securing opening 92 and 94 in alignment that can be used to secure the first 78 and second pet furniture apparatus 79 together to create the combined pet furniture apparatus 90. A securing device can be used to extend through the openings 92 and 94 to secure the first and second pet furniture apparatus together. The securing device can be any device known in the art for extending through openings to secure things together. Examples include, but are not limited to screws, nuts and bolts, threaded bolts, etc. In one embodiment, the openings 92 and 94 can be threaded. In yet another embodiment, the first pet apparatus 78 can include multiple openings 92 and the second pet apparatus 79 can include multiple openings 94 in general alignment with the openings 92 of the first pet furniture apparatus 78.

From the above description, it is clear that the present disclosure is well adapted to carry out the objectives and to attain the advantages mentioned herein as well as those inherent in the disclosure. While presently preferred embodiments have been described herein, it will be understood that numerous changes may be made which will readily suggest themselves to those skilled in the art and which are accomplished within the spirit of the disclosure and claims.

What is claimed is:

1. A pet furniture apparatus, the apparatus comprising:
a first set of vertical support elements extending from a base portion to a first level of platforms to create at least one compartment and a first floor;
at least one obstacle disposed in the at least one first level compartment to facilitate certain body movements of pets using the pet furniture apparatus; and
at least one engagement element for the pet to engage to induce interaction with the pet furniture apparatus.

2. The apparatus of claim 1 wherein the pet furniture apparatus includes multiple compartments on the first floor.

3. The apparatus of claim 1 wherein the pet furniture apparatus includes a second set of vertical support elements extending from the first level of platforms to a second level of platforms to create at least one second level compartment and a second floor and a third set of vertical support elements extending from the second level of platforms to a third level of platforms to create at least one third level compartment and a third floor.

4. The apparatus of claim 3 wherein the pet furniture apparatus further includes a fourth set of vertical support elements extending from the third level of platforms to create at least one fourth level compartment and a fourth floor.

5. The apparatus of claim 4 wherein the pet furniture apparatus includes vertical passages between adjacent floors and horizontal passages between adjacent compartments on the same floor.

6. The apparatus of claim 4 wherein the pet furniture apparatus can have a vertical passageway that extends from a first floor to a third floor or from a second floor to a fourth floor.

7. The apparatus of claim 4 wherein the pet furniture apparatus can have a vertical passageway that extends from a first floor to a fourth floor.

8. The apparatus of claim 1 wherein the pet furniture apparatus can have an access opening to allow a pet access to the pet furniture apparatus.

9. The apparatus of claim 8 wherein the access opening can have a layer of material disposed over the access opening wherein the layer of material has a slit disposed therein to permit a pet access to the pet furniture apparatus.

10. The apparatus of claim 5 wherein the vertical and horizontal passageways include obstacles to prevent certain pet movements and encourage certain pet movements as a pet maneuvers through the vertical and horizontal passageways.

11. An end table or coffee table having a dual purpose as a pet furniture apparatus, the table comprising:
a plurality of sides wherein each side has at least one access opening disposed therein and each side can be the top, bottom or side of the table;
a plurality of platform levels that creates multiple levels of compartments in a horizontal and vertical direction; and
a table top that can be configured to rest atop any side of the table that is facing upwards.

12. The table of claim 11 further comprising vertical and horizontal passageways disposed between the compartments.

13. The apparatus of claim 11 wherein the table includes six sides.

14. The apparatus of claim 13 wherein at least five of the sides of the table each includes at least two access openings.

15. The apparatus of claim 13 wherein at least three sides of the table each include at least three access openings.

16. The apparatus of claim 13 wherein at least three sides of the table each include at least four access openings.

17. The apparatus of claim 11 wherein the table can have at least one secure opening disposed in one of the sides that is in general alignment with at least one secure opening disposed in a second table wherein the two secure openings are used to secure the table to the second table to create a combined pet furniture apparatus that can be used as a table.

18. The apparatus of claim 11 wherein the table top is transparent so a pet owner can look down into the table and locate their pet inside.
